(19) United States
(12) Patent Application Publication
(10) Pub. No.: US 2005/0169354 A1
(43) Pub. Date: Aug. 4, 2005

(54) Systems and methods for searching interference canceled data

(76) Inventors: Eric S. Olson, Milwaukee, WI (US); Anand P. Narayan, Boulder, CO (US)

Correspondence Address: TENSORCOMM, INC., 1490 W. 121ST AVE., SUITE 105, WESTMINISTER, CO, 80234, US

(21) Appl. No.: 11/049,112

(22) Filed: Apr. 11, 2005

Related U.S. Application Data
(63) Continuation-in-part of application No. 10/838,924, filed on May 3, 2004.
(63) Continuation-in-part of application No. 10/763,346, filed on Jan. 23, 2004.

(51) Int. Cl. H04B 1/707

(52) U.S. Cl. 375/148

(57) ABSTRACT

Systems and methods for searching interference-canceled data are presented. A searcher finger is configured for acquiring a signal that is buried beneath the noise and interference floor due to interference from other signals. The searcher finger can either search for a signal within an uncanceled digital signal or within a substantially interference canceled signal. The substantially interference canceled signal has one or more interfering signals substantially canceled from the digital signal. A Coded Signal Processing Engine is configured for a generating the substantially interference canceled signal by performing signal cancellation on an input signal and transferring the resulting signal to the searcher finger. The searcher finger acquires a signal within the substantially interference canceled signal. The signal cancellation of the processing engine may improve the signal to noise ratio of a signal, which may improve acquisition of the signal by the searcher finger.

### BACKGROUND OF THE INVENTION

1. Field of the Invention

The present invention generally relates to acquiring a signal within a plurality of signals and more specifically to sending interference canceled data to a searcher finger of a receiver to acquire the signal. The signals are coded signals and may comprise Code Division Multiple Access (“CDMA”) signals, Broadband CDMA, Wideband Code Division Multiple Access (“W-CDMA”) signals, Global Positioning System (“GPS”), Universal Mobile Telecommunications System (“UMTS”) signals or combinations thereof.

2. Description of the Related Art

Receivers typically search a signal environment for a selected signal path, or Signal Path Of Interest (“SPOI”). The signal path may be selected due to a property of the signal path (e.g., energy of the signal path). Some signal paths within the environment may interfere with the SPOI. For example, a coded signal path from one transmitter may interfere with the reception of a coded signal path from either the same transmitter or another transmitter. Because of code similarities and corresponding energies of the coded signal paths, the signal paths may interfere with one another and hinder detection of the SPOI. The lack of orthogonality in the codes used to encode the signals may result in leakage between signal paths. Examples of these codes include spreading codes and covering codes, both of which are known to those skilled in the art.

In CDMA communication, pseudorandom number, or pseudo-noise, (PN) spreading codes are often used to encode data signals. For example, to encode the data signals, a spreading code may be applied to the data at a chipping rate that is faster than that of the data symbol rate, such that there are multiple “chips” of the code for any data symbol. The transmitter may, therefore, transmit a symbol comprising a plurality of chips. Such an application of the spreading code is commonly referred to as direct sequence spreading of the data. Chips and their associated chipping rates are known to those skilled in the art. PN codes are also known to those skilled in the art.

In a CDMA telephony system, each base station (i.e., transceiver) may be assigned a particular timing offset of the spreading code to differentiate between base stations. Mobile units may therefore identify a particular base station based on the timing offset of the spreading code. Additionally, spread signals are often further encoded with a unique “covering” code to provide “channelization” of a signal. These covering codes often include families of codes that are orthogonal (e.g., Walsh codes) or codes that are substantially orthogonal (e.g., Quasi-Orthogonal Functions “QOFs”). Walsh covering codes and QOF covering codes have properties that allow for channelization of signals and are known to those skilled in the art.

Both spreading codes and covering codes may be used in the detection and acquisition of a selected signal. However, interference caused by similarly encoded signals may still preclude detection of the selected signal. For example, as a mobile unit communicates with a base station within its coverage cell, signals from other base stations and/or other mobiles can interfere with that communication. Specifically, on the forward link, or down-link, (i.e., communication from the base station to the mobile unit) other base stations can interfere with the reception of signals at the mobile unit. Since cells often overlap one another to ensure that most if not all desired geographic regions are included within the coverage of a communication system, one or more signals from one base station may interfere with communication between another base station and the mobile unit. This phenomenon is referred to herein as “cross-channel interference.”

These signals can “bleed” into other cells and interfere with a selected signal, thereby corrupting conveyed data. Examples of such interfering signals include: pilot channels, which convey reference information and are also used to coherently demodulate channels; paging channels, which may convey paging information; synchronization channels, which may provide synchronization information between a base station and a mobile unit. Traffic channels, which convey digital information (e.g., data and/or voice), are yet another example of interfering signals.

Other forms of interference may occur from “multipath” copies of a selected signal that follow separate paths. Multipath can create interference because time and/or phase misaligned copies of a selected signal may be received simultaneously. For example, a plurality of multipath signals arriving at a receiver simultaneously may result in a misalignment of spreading and/or covering codes. Multipath thereby creates “co-channel interference” because, among other reasons, the spreading code may only be pseudo-orthogonal and the orthogonality of the covering code between channels is essentially lost due to timing offsets and/or phase differences between the multipath signals.

Multipath typically occurs because of obstructions in the transmission path, such as buildings, trees, et cetera, that can create multiple transmission paths for a selected signal. These signal paths travel unique paths that may cause copies of a signal to differentially arrive at a receiver. Additionally, these multipath signals may bleed over into other cells resulting in cross-channel interference.

“Rake” receivers, such as those used in CDMA telephony systems, typically have at least one “searcher finger” for detection of a Signal Of Interest (“SOI”) from a signal environment comprising cross-channel and/or co-channel interference. Such interference may have sufficient energy so as to leave an SOI undetectable. For example, due to the cross-channel and/or co-channel interference, an SOI may be “buried” in the noise and interference floor such that a searcher finger is unable to detect a SPOI.

### SUMMARY OF THE INVENTION

Systems and methods for searching substantially interference-canceled data are presented. In one embodiment, a searcher finger is configured for acquiring a signal path that is buried beneath the noise and interference floor due to interference from other signals paths. The searcher finger can either search for an SOI within a digital received signal or it can search for the SOI within an interference canceled signal, wherein the interference canceled signal has one or more interfering signals substantially canceled from the digital signal.

In one embodiment, the location of an SOI is provided in a neighbor list transmitted by a base station. For example, after a blind acquisition that determines the location of the base station with the strongest signal, such as when the handset is initially turned on, the searcher finger may search for the SOI in the interference canceled signal over “search windows” that are specified by the neighbor list. A neighbor list may specify nearby base stations, their location in the PN code sequence and/or a search window size. The size of the search window may be adjusted to accommodate a number of canceled data streams to be searched and/or an uncanceled data stream. For example, if a searcher finger has to search both canceled and uncanceled streams; adjustments to the search window size may be necessary (e.g. searching over a smaller search window and/or searching windows more quickly) in order to accommodate these multiple searches. Neighbor lists and search windows are well known to those skilled in the art.

In another embodiment of the invention, a Coded Signal Processing Engine (“CSPE”) is configured for generating a substantially interference canceled signal and transferring it to a searcher finger. For example, the CSPE may perform a signal cancellation such as that described in the '346 application to generate a substantially interference canceled signal. Once generated, the canceled signal may be transferred to the searcher finger for detection of an SOI within the interference-canceled signal. As with the '346 application, the signal cancellation may be performed on either a received signal y or a reference code x.

Signal cancellation performed by the CSPE may improve the Signal to Noise Ratio (“SNR”) of an SOI because it may reduce the energy of interfering signals relative to the energy of the SOI. For example, the SNR of an SOI may be represented as the energy per chip E_{C} of the SOI divided by the total received signal energy I₀. The total energy I₀ is the sum of interference Iᵢₙₜ and noise N₀. A reduction in Iᵢₙₜ corresponds to a reduction in I₀. As I₀ is decreased relative to E_{c}, the SNR of the SOI increases. This improved SNR may improve acquisition of the SOI. The embodiments shown and described herein may be particularly advantageous to systems employing CDMA communications because of the use of codes in CDMA to differentiate transmitters and/or channels. However, the invention is not intended to be limited to such systems as other coded signals may enjoy similar advantages. Additional embodiments of the invention and corresponding advantages of particular embodiments will be apparent in view of the detailed description that follows.

### BRIEF DESCRIPTION OF THE DRAWINGS

FIG. 1 is a block diagram illustrating a CSPE configured for transferring substantially interference-canceled data to a searcher finger, in one exemplary embodiment of the invention.

FIG. 2 is a block diagram of a CSPE configured with a receiver having a searcher finger in one exemplary embodiment of the invention.

FIG. 3 is a block diagram of a CSPE configured with a receiver, wherein the receiver comprises a plurality of searcher fingers in one exemplary embodiment of the invention.

FIG. 4 is a block diagram of a CSPE having a searcher finger and configured with a receiver in one exemplary embodiment of the invention.

FIG. 5 is a block diagram of a CSPE having a plurality of searcher fingers and configured with a receiver in one exemplary embodiment of the invention.

FIG. 6 is a block diagram of a cancellation processor in one exemplary embodiment of the invention.

FIG. 7 is a flowchart of one exemplary methodical embodiment of the invention.

### DETAILED DESCRIPTION OF THE DRAWINGS

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the spirit and scope of the invention as defined by the claims.

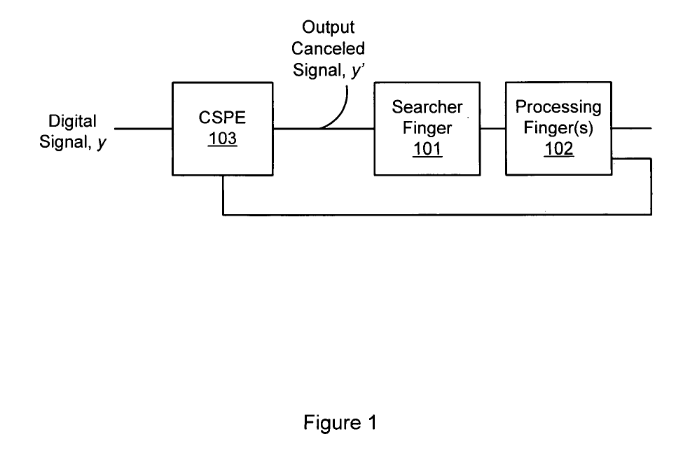

FIG. 1 is a block diagram illustrating CSPE 103 configured for transferring substantially interference-canceled data to searcher finger 101 in one exemplary embodiment of the invention. In this embodiment, CSPE 103 is configured for receiving a digital signal y and for substantially canceling one or more interfering signals from the digital signal to generate a substantially interference canceled signal. Searcher finger 101 is communicatively coupled to CSPE 103 and is configured for detecting and acquiring a selected signal of interest, or an SOI, from the interference canceled signal or the uncancelled signal. Once the SPOI is acquired, searcher finger 101 may transfer signal parameters to processing finger(s) 102 for tracking and demodulation of the SOI. The processing fingers 102 provide tracking information of the tracked signals (e.g., phase information and/or PN code/time tracking). The processing finger(s) may transfer tracking information to CSPE 103. Since CSPE 103 introduces delay due to cancellation processing, the transferred time tracking information is not time aligned to the signal stream. The PN code offset is therefore advanced in time by an amount substantially equivalent to the delay introduced by CSPE 103. A constant phase approximation may be made over the duration of the delay.

Signal cancellation of this embodiment may be performed according to the '346 application. For example, CSPE 103 may be configured for generating a cancellation operator that when applied to an input signal substantially cancels interfering signals from the input signal. Similarly, CSPE 103 may be configured to directly generate a substantially interference canceled input signal. The input signal may comprise any of a digital signal y, an interference canceled signal y′, a reference code x or an interference canceled reference code x′, as described in the '346 application.

In one embodiment of the invention, the cancellation operator is a projection operator generated according to the following form:
Pₛ^{⊥}=I−S(S^{T}S)⁻¹S^{T}, (Eq. 1)
where Pₛ^{⊥} is the projection operator, I is an identity matrix, S is an interference matrix and S^{T} is a transpose of the interference matrix. In this embodiment, CSPE 103 may select certain interfering signals from a received digital signal y and construct an interference matrix from the selected interfering signals. Each column vector of the interference matrix may represent one or more interfering signals (e.g. signal paths and channels). CSPE 103 may correspondingly generate the projection operator Pₛ^{⊥} using the interference matrix according to Eq. 1. Similarly, the canceled signal may be generated directly according to the following form:
Pₛ^{⊥}y=y−S(S^{T}S)⁻¹S^{T}y. (Eq. 2)

CSPE 103 may apply the projection operator to an input signal, such as those previously mentioned herein. Application of the projection operator to the input signal projects the input signal onto a subspace that is substantially orthogonal to a subspace comprising the interfering signals. This projection operation substantially removes the effects of the interfering signals upon the SOI because the energy of the interfering signals is substantially reduced in relation to the energy of the signals not selected for cancellation. Searcher finger 101 may, therefore, more effectively detect an SOI because the SNR of the SOI may be improved. For example, the strength of the SOI may be raised above the noise and interference floor.

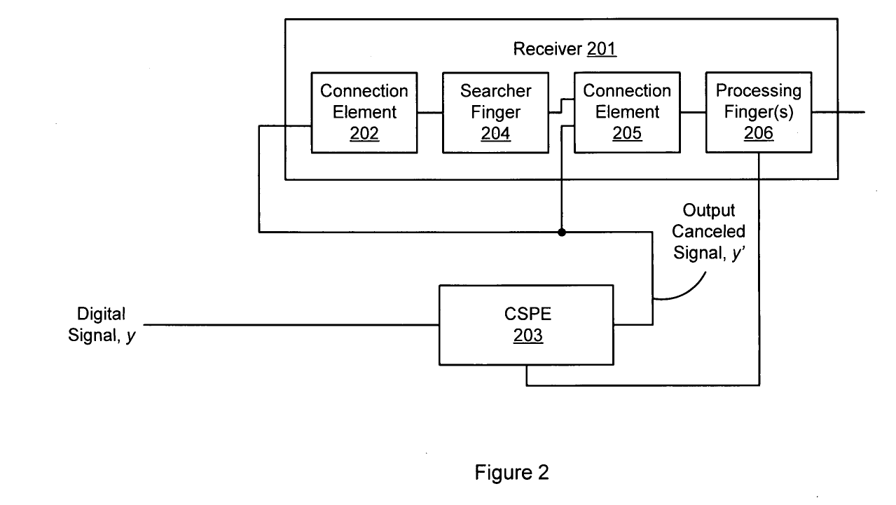

FIG. 2 is a block diagram of CSPE 203 configured with receiver 201 having searcher finger 204 in one exemplary embodiment of the invention. In this embodiment, CSPE 203 operates similarly to CSPE 103 of FIG. 1 by generating a cancellation operator and applying the cancellation operator to an input signal to substantially remove one or more interfering signals from the input signal. In response to substantially removing the interfering signals, CSPE 203 generates a substantially interference canceled signal (i.e., labeled output canceled signal y′) which is subsequently transferred to receiver 201.

In this embodiment, receiver 201 comprises a pair of connection elements (i.e., elements 202 and 205), searcher finger 204 and processing finger(s) 206. Receiver 201 receives a signal y and/or output canceled signal y′ for selection by connection element 202. Connection element 202 is configured for selecting between the signal y and output canceled signals y′ generated by CSPE 203. The received signal y may be delayed to account for any delays attributable to the signal cancellation processing by CSPE 203. In a serial cancellation scheme, output canceled signals y′ may be delayed as well. Such a delay may time-align the received signal y and the output canceled signals y′ for acquisition by searcher finger 204.

Connection element 202 may select either the delayed signal y or an output canceled signal y′ based on a predetermined criteria. For example, a decision may be made to select either signal based on the SNR, or energy, values of the signals. Alternatively, the decision may be made if there are available processing fingers 206. If an SOI has a sufficiently strong SNR, a search of the output canceled signal y′ by searcher finger 204 may not be necessary and the search may be performed over the delayed uncancelled signal y. If, however, the SNR of the SOI is sufficiently weak, such that the SPOI cannot be acquired, a search of the output canceled signal y′ by searcher finger 204 may be deemed necessary. Similarly, if processing fingers 206 are available and additional multipath signals cannot be found, a search of the output canceled signal y′ by searcher finger 204 may be deemed necessary.

Once the signal selection by connection element 202 is made, the signal is transferred to searcher finger 204 for acquisition. The SNR of the multipath should be sufficiently strong so that the multipath may be acquired in either the output canceled signal y′ or the delayed signal y. The SNR of an SOI may be improved by searching the output canceled signal y′ (i.e., the signal resulting from signal cancellation processing by CSPE 203). Accordingly, searcher finger 204 may acquire the multipath associated with the SOI and transfer one or more parameters associated with its location in the PN sequence to connection element 205.

Connection element 205 is configured for selecting between acquisition information from either an uncancelled signal stream y or the output canceled signal stream y′ generated by CSPE 203 for each processing finger 206. Moreover, it selects which data stream to transfer to processing finger(s) 206. Again, the selection may be made with respect to some predetermined criteria, such as SNR of the SOI. Connection element 205 may select and transfer one or more parameters associated with a signal path acquired by searcher finger 204 in the uncancelled signal stream or a canceled signal stream to processing fingers 206 for increased SNR of the SOI.

Those skilled in the art should readily recognize that the invention is not intended to be limited to the embodiment shown and described herein. Other embodiments may fall within the scope and spirit of the invention. For example, receiver 201 may comprise a plurality of searcher fingers 204 and processing fingers 206. One example of such embodiment may include a rake receiver having a plurality of processing fingers, each configured for tracking and demodulating an assigned SOI. Accordingly, the invention should only be limited to the language recited in the claims and their equivalents.

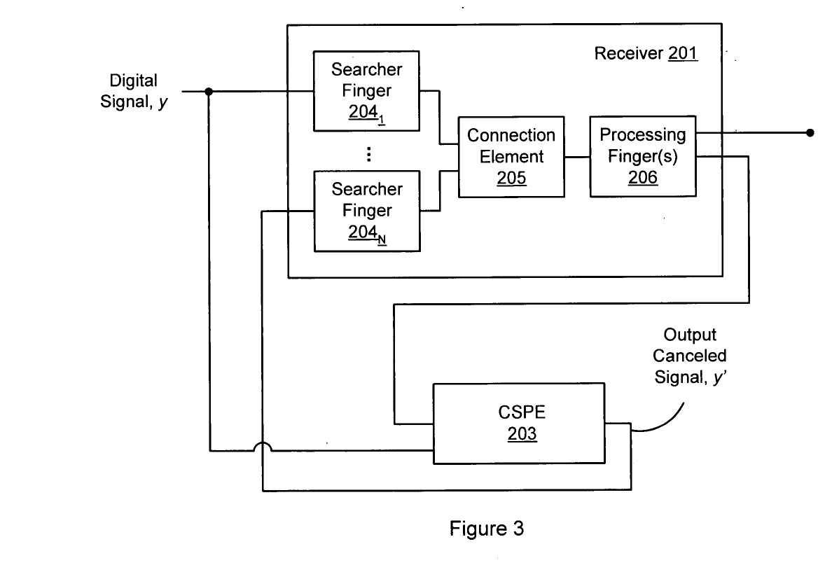

FIG. 3 is block diagram of CSPE 203 configured with receiver 201, wherein the receiver comprises a plurality of searcher fingers 204_{1 . . . N} in one exemplary embodiment of the invention. In this embodiment, one or more searcher fingers 204 are configured for receiving a signal, wherein each searcher is configured for searching for an SPOI within that signal. One or more of the searcher fingers 204 are auxiliary searcher fingers 204 which are communicatively coupled to CSPE 203 and are configured for searching for a SOI within output canceled signal y′ as generated by the CSPE. The remaining searcher finger(s) are configured for receiving a delayed signal y, wherein the delay of the signal may compensate for any delays introduced by signal cancellation processing of CSPE 203.

CSPE 203 is configured for generating the output canceled signal y′ as described hereinabove. CSPE 203 is communicatively coupled to the auxiliary searcher fingers 204 such that the searcher fingers may detect and/or acquire one or more SPOIs for subsequent tracking and demodulation. Connection element 205 is configured for selecting SPOIs detected within output canceled signal y′ and/or SPOIs detected within the delayed signal y. Connection element 205 transfers acquisition (e.g., PN code) information of the selected one or more SPOIs and the corresponding signal stream to processing finger(s) 206 for subsequent tracking and demodulation of the selected signal(s).

As shown herein, CSPE 203 is configured for receiving one or more signals from processing finger 206(s) as well as tracking and/or phase information of SPOIs. CSPE 203 may select interfering signals from a signal stream and substantially cancel the interference with one or more cancellation operators as previously described herein. For example, processing finger(s) 206 may be representative of a plurality of processing fingers such as those used in a rake receiver. Accordingly, the processing fingers may track and demodulate a plurality of SPOIs (i.e., either within the signal y and/or the output canceled signal y′).

While one exemplary preferred embodiment has been shown and described herein, those skilled in the art should readily recognize that other embodiments may fall within the scope and spirit of the invention. Accordingly, the invention is not intended to be limited by the exemplary preferred embodiment. Rather, the invention is only intended to be limited by the language recited in the claims and their equivalents.

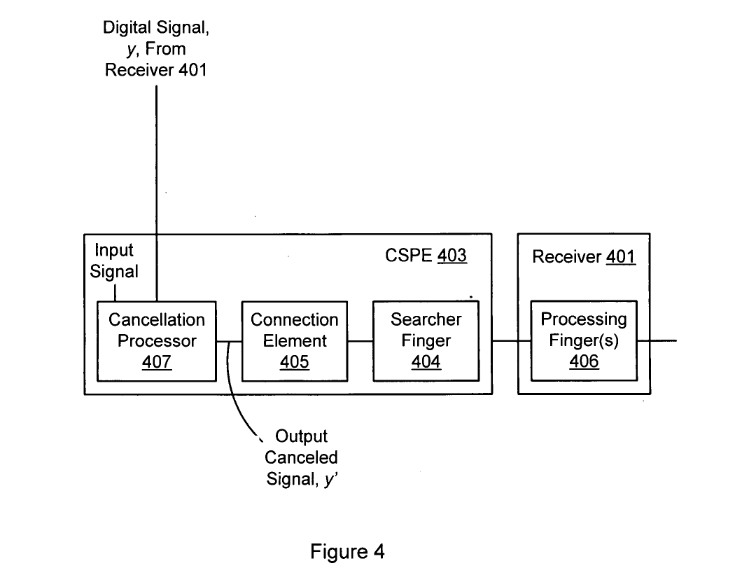

FIG. 4 is a block diagram of CSPE 403 having searcher finger 404 and configured with receiver 401 in one exemplary embodiment of the invention. In this embodiment, receiver 401 may receive an analog signal and convert that signal into a digital baseband signal y for processing within the receiver. The digital signal y may also be transferred to CSPE 403 for interference selection and signal cancellation according to the '346 application. Searcher finger 404 of CSPE 403 is configured for acquiring an SPOI within an output canceled signal y′. Once acquired, searcher finger 404 transfers one or more SPOI parameters to processing finger(s) 406 of the receiver 401 for subsequent tracking and demodulation of the SPOI.

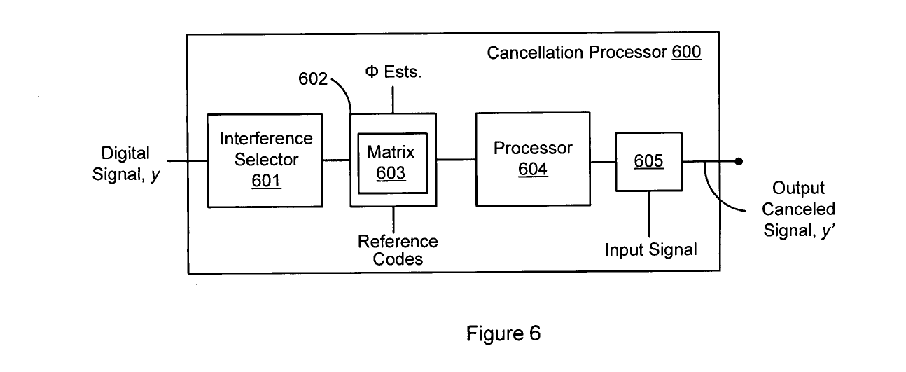

CSPE 403 comprises a cancellation processor 407, which is configured for generating and applying a cancellation operator to an input signal. Such generation and application of the cancellation operator may be performed as described hereinabove and below in FIG. 6. Phase estimates and on-time PN code sequences may be produced by processing finger(s) 406. In this embodiment, CSPE 403 may advance the on-time PN sequence by an amount substantially equivalent to the delay introduced by CSPE 403 processing such that the PN sequence is appropriately time-aligned with the digital signal y. A constant phase approximation may be made over the delay, so that the delayed phase estimate may be used with the advanced PN sequence. Cancellation processor 407 receives a digital signal y from receiver 401 and selects certain interfering signals within that received digital signal y for cancellation.

Cancellation processor 407 uses the selected interfering signals to construct an interference matrix, such as that described in the 'TCOM0020 application. The interference matrix may be comprised of one or more interference vectors, wherein each vector is comprised of one or more interferers. Each vector may be formed from one or more interfering signals comprising spreading codes, covering codes, phase estimates, sign estimates of each received symbol and/or relative amplitude estimates of each received symbol.

Connection element 405 is communicatively coupled to, or configured within, CSPE 403 and is configured for selecting either of the output canceled signal y′ from CSPE 403 or the digital signal y as delayed within or outside CSPE 403. The delay may be performed by any of a plurality of well-known devices configured for delaying a signal, such as a buffer. The delay of the digital signal y is of a duration that is substantially equivalent to any delay attributable to CSPE 403. For example, CSPE 403 introduces a signal delay because of signal cancellation processing (e.g., a 2 symbol delay). Accordingly, the delay of y may compensate for a delay introduced by CSPE 403 such that the output canceled signal y′ and the signal y are time aligned.

Once selected by connection element 405, the signal is transferred to searcher finger 404 for acquisition of an signal path therein. Accordingly, searcher finger 404 may search for the signal path in either the substantially canceled or uncanceled signals. Information about an acquired signal path is subsequently transferred from searcher finger 404 to processing finger 406 for subsequent tracking and demodulation of the SPOI along with the appropriate signal (i.e., y or y′).

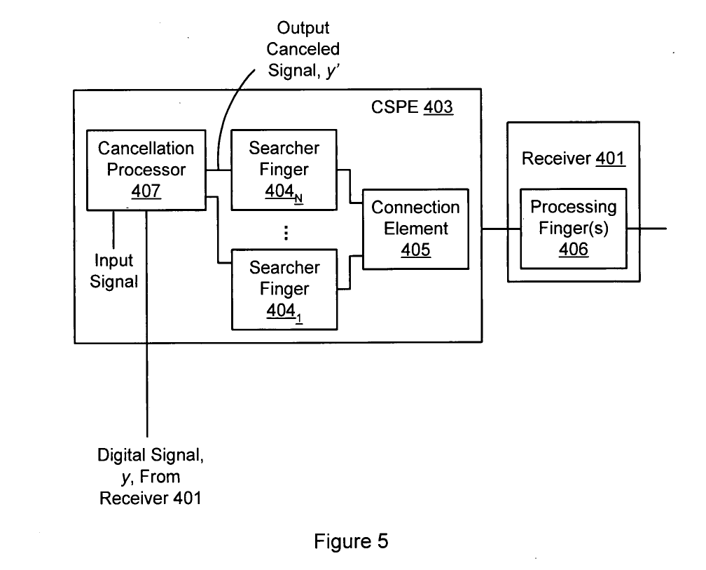

Although shown and described as having one searcher finger 404, other embodiments may include a plurality of searcher fingers. For example, below in FIG. 5 CSPE 403 is configured as having a plurality of searcher fingers 404. Accordingly, the invention is not intended to be limited to the exemplary embodiment shown herein. Rather, the invention should only be limited by the language recited in the claims and their equivalents.

FIG. 5 is a block diagram of CSPE 403 having a plurality of searcher fingers 404 and configured with receiver 401 in one exemplary embodiment of the invention. In this embodiment, CSPE 403 comprises searcher fingers 404_{1 . . . N}, each of which is configured for acquiring signal path within a digital signal transferred thereto. A subset of these searcher fingers 404 receives a digital signal y from receiver 401. CSPE 403 may be configured for delaying the signal to compensate for any delays introduced by CSPE 403 for the purpose of time-aligning the signals y and y′.

CSPE 403 comprises a cancellation processor 407, which is configured for generating and applying a cancellation operator to substantially cancel interfering signals from an input signal. The cancellation processor 407 may receive the digital signal y and select certain interfering signals comprised with that digital signal for cancellation. In one embodiment, cancellation processor 407 performs signal cancellations on one or more input signals to generate a corresponding set of output canceled signals (e.g., canceled signals y′). These output canceled signals y′ are thereby transferred to a subset of searcher fingers 404 for acquisition of SOIs. For example, cancellation processor 407 may perform a parallel signal cancellation on a plurality of input signals, such as described in the 'TCOM0019 application, to generate a corresponding plurality of output canceled signals. Each of these output canceled signals may be transferred to a corresponding searcher finger 404 for acquisition of a signal path within the signal transferred thereto.

Parameters associated with acquired signal paths (i.e., those from both subsets of searcher fingers 404) may be transferred to connection element 405 for selective transfer of the parameters along with the signals y and/or y′ to one or more processing finger(s) 406 of receiver 401. For example, connection element 405 may selectively transfer one or more of the signals acquired by the searcher fingers 404. The signals transferred may be SPOIs acquired from either the output canceled signals and/or from the uncanceled signal (i.e., digital signal y). The transferred signals are subsequently tracked and demodulated by processing finger(s) 406 of receiver 401.

FIG. 6 is a block diagram of cancellation processor 600 in one exemplary embodiment of the invention. In this embodiment, cancellation processor 600 is configured for generating a cancellation operator and applying a cancellation operator to an input signal. The cancellation processor 600 comprises an interference selector 601 for receiving a digital signal and selecting interfering signals from the digital signal for construction of an interference matrix 603. Once selected, the interfering signals are transferred to matrix generator 602, which subsequently generates interference matrix 603. Phase estimates and reference codes of the interfering signals are also transferred to matrix generator 602 to assist in matrix 603 construction. Such interference selection and matrix construction may be performed according to the 'TCOM0020 application.

The cancellation processor 600 also comprises processor 604 for generating a cancellation operator from matrix 603. For example, processor 604 may generate a projection operator according to Eq. 1 described above herein using matrix 603. The cancellation operator may then be applied to an input signal via applicator 605 to substantially cancel the one or more interfering signals used in the construction of matrix 603. Accordingly, cancellation processor 600 generates an output canceled signal y′ through the application of the cancellation operator to an input signal.

Although shown and described in this embodiment as generating one interference canceled signal, those skilled in the art should readily recognize that cancellation processor 600 may be configured to generate a plurality of output canceled signals y′. For example, the '924 and '346 applications illustrate embodiments in which a plurality of cancellation operators are generated and applied to a corresponding plurality of input signals. Accordingly, the invention is not intended to be limited to the generation and subsequent application of the cancellation operator of this exemplary preferred embodiment. Rather, the invention is only intended be limited to the language recited in the claims and their equivalents.

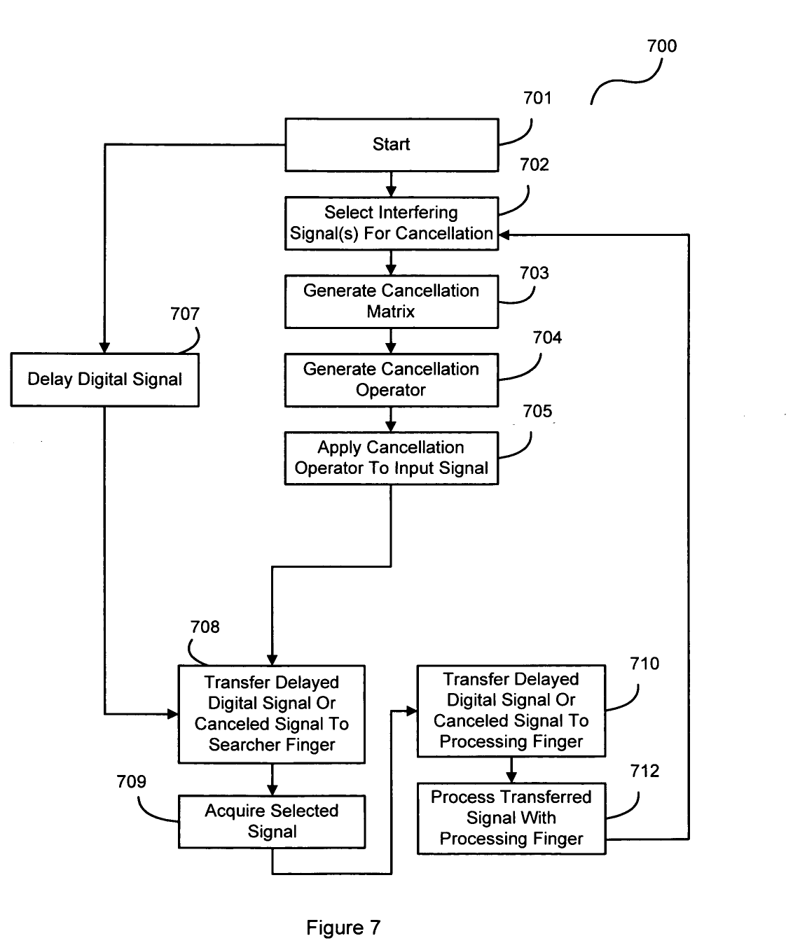

FIG. 7 is a flowchart 700 of one exemplary methodical embodiment of the invention. In this embodiment, signal detection is started in common element 701. In element 701, a digital signal, such as described hereinabove, may be transferred to a CSPE. The digital signal may be delayed in element 707 and/or transferred to element 702 for selecting interfering signals for cancellation.

Signals that are selected for cancellation are used by the CSPE to generate a cancellation matrix, in element 703. From the cancellation matrix, the CSPE generates a cancellation operator in element 704. The CSPE may then apply the cancellation operator to an input signal in element 705 to substantially cancel, or remove, the interfering signals from the input signal. For example, the cancellation operator may be a projection operator as described in Eq. 1 that when applied to an input signal projects the input signal onto a subspace that is substantially orthogonal to a subspace spanned by the interfering signals. This application of the cancellation operator generates a substantially interference canceled signal.

Once the interference is substantially canceled, the substantially interference canceled signal is selectively transferred to a searcher finger in element 708 (i.e., either the delayed digital signal from element 707 or the substantially interference canceled signal from element 705 is transferred to the searcher finger) for acquisition of signal path. The searcher finger thereby searches the transferred signal and acquires the SPOI, in element 709. Once acquired, parameters associated with the SPOI may be transferred to a processing finger for tracking and processing (e.g., as in element 710). Furthermore, either the delayed digital signal or a substantially interference canceled signal is selectively transferred to a processing finger in element 710. Once transferred, the signal is processed by the processing finger, in element 712. This processing may include tracking and demodulation of the transferred signal and/or the estimation of phase and/or an on-time reference code for signal cancellation purposes. The estimates of phase and/or on-time reference codes may be transferred to element 702 for interference cancellation.

Signal cancellation as described in the above embodiments may be performed on a received signal y, an interference canceled signal y′, a reference code x and/or an interference canceled reference code x′. Such signal cancellation may be advantageous for use within handset transceivers and/or base station transceivers. For example, the above embodiments may improve signal diversity since more signals may be seen and acquired via signal cancellation.

While the exemplary embodiments are described herein as CDMA systems, the invention is not intended to be limited to such embodiments. Rather, other embodiments that fall within the scope and spirit of invention may be implemented in systems using CDMA signals (e.g., such as cdmaOne and cdma2000), Broadband CDMA signals, W-CDMA signals, GPS signals, UMTS signals and/or other coded signals.

Additionally, it should be noted that the above embodiments of the invention may be implemented in a variety of ways. For example, the above embodiments may be implemented in software, firmware, hardware or various combinations thereof. Those skilled in the art are familiar with software, firmware, hardware and their various combinations. To illustrate, those skilled in the art may choose to implement certain aspects of the invention in hardware using Application Specific Integrated Circuit (“ASIC”) chips, Field Programmable Gate Arrays (“FPGAs”), Digital Signal Processors (“DSPs”) and/or other circuitry. Still, some aspects of the invention may be implemented through combinations of software using C, C++, VHDL, Verilog, and/or processor specific machine and assembly languages. Accordingly, those skilled in the art should readily recognize that such implementations are a matter of design choice and that the invention should not be limited to any particular implementation.

Computer programs (i.e., software and/or firmware) implementing the method of this invention will commonly be distributed to users on a distribution medium such as a SIM card, a USB memory interface, or other computer-readable memory adapted for interfacing with a consumer wireless terminal. Similarly, computer programs may be distributed to users via wired or wireless network interfaces. From there, they will often be copied to a hard disk or a similar intermediate storage medium. When the programs are to be run, they will be loaded either from their distribution medium or their intermediate storage medium into the execution memory of the wireless terminal, configuring an onboard digital computer system (e.g. a microprocessor) to act in accordance with the method of this invention. All these operations are well known to those skilled in the art of computer systems.

The term “computer-readable medium” encompasses distribution media, intermediate storage media, execution memory of a computer, and any other medium or device capable of storing for later reading by a digital computer system a computer program implementing the method of this invention.

Various digital computer system configurations can be employed to perform the method embodiments of this invention, and to the extent that a particular system configuration is capable of performing the method embodiments of this invention, it is equivalent to the representative system embodiments of the invention disclosed herein, and within the scope and spirit of this invention.

Once digital computer systems are programmed to perform particular functions pursuant to instructions from program software that implements the method embodiments of this invention, such digital computer systems in effect become special-purpose computers particular to the method embodiments of this invention. The techniques necessary for this programming are well known to those skilled in the art of computer systems.

While the invention has been illustrated and described in detail in the drawings and foregoing description, such illustration and description is to be considered as exemplary and not restrictive in character. Accordingly, it should be understood that only the preferred embodiment and minor variants thereof have been shown and described and that all changes and modifications that come within the spirit of the invention are desired to be protected.

1. A system, comprising:
a processor configured for substantially canceling one or more interfering signals from a digital signal to generate a substantially interference-canceled signal; and
a first searcher finger communicatively coupled to the processor and configured for performing acquisition to produce an acquired signal from the substantially interference-canceled signal.

2. The system of claim 1, further comprising a processing finger communicatively coupled to the first searcher finger and configured for processing the acquired signal.

3. The system of claim 2, further comprising a connection element configured for selectively transferring either an uncancelled signal or the substantially interference-canceled signal to the processing finger.

4. The system of claim 1, further comprising a connection element configured for selectively transferring either the digital signal or the substantially interference-canceled signal to the first searcher finger for acquisition of the acquired signal.

5. The system of claim 4, further comprising a buffer configured within the processor and communicatively coupled to the connection element, wherein the buffer is configured for applying a first delay to the digital signal.

6. The system of claim 5, wherein the first delay comprises a duration of time corresponding to a second delay introduced by the processing engine.

7. The system of claim 1, further comprising a second searcher finger configured for receiving a time-delayed said digital signal and for acquiring the acquired signal from the time-delayed said digital signal.

8. The system of claim 7, wherein the second searcher finger is configurable within a processing engine and wherein the processing engine comprises the processor.

9. The system of claim 1, wherein the first searcher finger is configurable within a processing engine and wherein the processing engine comprises the processor.

10. The system of claim 1, wherein the first searcher finger is configurable within a receiver and wherein the receiver comprises a processing finger communicatively coupled to the first searcher finger for processing an acquired said acquired signal.

11. The system of claim 10, wherein the receiver is configurable with a handset.

12. The system of claim 10, wherein the receiver is configurable with a base station.

13. The system of claim 1, further comprising a second searcher finger configurable within a receiver and wherein the receiver comprises a processing finger communicatively coupled for processing an acquired signal from either the first searcher finger or the second searcher finger.

14. The system of claim 1, wherein the processor is configured for generating a cancellation operator, wherein the cancellation operator is adapted to be used to substantially cancel the one or more interfering signals from the digital signal.

15. The system of claim 14, further comprising an applicator configured for applying the cancellation operator to an input signal to substantially cancel the one or more interfering signals from the input signal, wherein the input signal comprises the digital signal or a reference code.

16. The system of claim 1, further comprising a matrix generator configured for generating a cancellation matrix adapted to be used to generate a cancellation operator, wherein the cancellation operator is adapted to be used to substantially cancel the one or more interfering signals from the digital signal.

17. The system of claim 16, wherein the cancellation operator comprises the form:
Pₛ^{⊥}=I−S(S^{T}S)⁻¹S^{T},
wherein Pₛ^{⊥} is the cancellation operator, I is an identity matrix, S is the cancellation matrix and S^{T} is a transpose of the cancellation matrix.

18. The system of claim 1, further comprising an interference selector configured for selecting the one or more interfering signals for cancellation from a plurality of interfering signals.

19. The system of claim 1, wherein the acquired signal is one of a group, the group consisting of: a CDMA signal; a WCDMA signal; a UMTS signal; and a GPS signal.

20. A method, comprising:
providing for generating a cancellation operator;
providing for applying the cancellation operator to a digital signal to substantially cancel an interfering signal from the digital signal and generate a substantially interference canceled signal; and
providing for acquiring, with a first searcher finger, a selected signal from the substantially interference canceled signal.

21. The method of claim 20, further comprising providing for selecting the interfering signal for cancellation.

22. The method of claim 21, further comprising providing for generating a cancellation matrix from the interfering signal in response to selecting.

23. The method of claim 22, wherein providing for generating the cancellation operator comprises providing for generating the cancellation operator from the cancellation matrix according to the form:
Pₛ^{⊥}=I−S(S^{T}S)⁻¹S^{T},
wherein Pₛ^{⊥} is the cancellation operator, I is an identity matrix, S is the cancellation matrix and S^{T} is a transpose of the cancellation matrix.

24. The method of claim 20, further comprising providing for selectively transferring either a received signal or the substantially interference canceled signal to a processing finger in response to providing for acquiring.

25. The method of claim 24, further comprising providing for processing the substantially interference canceled signal with the processing finger.

26. The method of claim 24, further comprising providing for processing an acquired said selected signal with the processing finger.

27. The method of claim 20, further comprising selectively transferring either the digital signal or the substantially interference canceled signal to the first searcher finger in response to providing for applying.

28. The method of claim 20, further comprising providing for applying a first delay to the digital signal when providing for generating the cancellation operator to generate a time delayed said digital signal.

29. The method of claim 20, further comprising providing for acquiring, with a second searcher finger, the selected signal from the digital signal.

30. A method, comprising:
providing for substantially canceling one or more interfering signals from an input signal by applying a cancellation operator to the input signal to produce an output canceled signal;
providing for acquisition of the output canceled signal to produce an acquired signal in response to providing for substantially canceling the one or more interfering signals from the input signal.

31. The method of claim 30, further comprising providing for detection of a digital signal to produce a detected digital signal while detecting the acquired signal from the output canceled signal.

32. The method of claim 31, further comprising providing for delaying the digital signal to account for a delay introduced by substantially canceling the one or more interfering signals.

33. The method of claim 31, further comprising providing for processing either the detected digital signal or the acquired signal detected from the output canceled signal.

34. The method of claim 33, wherein processing comprises:
providing for tracking the selected signal; and
providing for demodulating the selected signal to extract data from the selected signal.

35. The method of claim 30, further comprising providing for generating the cancellation operator from an interference matrix constructed of the one or more interfering signals.

36. The method of claim 35, wherein providing for generating the cancellation operator comprises providing for generating a projection operator according to the following form:
Pₛ^{⊥}=I−S(S^{T}S)⁻¹S^{T},
wherein Pₛ^{⊥} is the projection operator, I is an identity matrix, S is the interference matrix and S^{T} is a transpose of the interference matrix.

37. A digital computer system programmed to perform the method of claim 20, 21, 22, 23, 24, 25, 26, 27, 28, 29, 30, 31, 32, 33, 34, 35, or 36.

38. A computer-readable medium storing a computer program implementing the method of claim 20, 21, 22, 23, 24, 25, 26, 27, 28, 29, 30, 31, 32, 33, 34, 35, or 36.

39. A system, comprising:
means for generating a cancellation operator;
means for applying the cancellation operator to a digital signal to substantially cancel an interfering signal from the digital signal and generate a substantially interference-canceled signal; and
means for performing acquisition with a first searcher finger to produce an acquired signal from the substantially interference-canceled signal.

40. The system of claim 39, further comprising means for selecting the interfering signal for cancellation.

41. The system of claim 40, further comprising means for generating a cancellation matrix from the interfering signal in response to selecting.

42. The system of claim 41, wherein the means for generating the cancellation operator comprises means for generating the cancellation operator from the cancellation matrix according to the form:
Pₛy^{⊥}=y−S(S^{T}S)⁻¹S^{T}y,
wherein Pₛ^{⊥} is the cancellation operator, y is the digital signal, I is an identity matrix, S is the cancellation matrix and S^{T} is a transpose of the cancellation matrix.

43. The system of claim 39, further comprising means for selectively transferring either a received signal or the substantially interference-canceled signal to a processing finger in response to acquiring.

44. The system of claim 43, further comprising means for processing the substantially interference-canceled signal with the processing finger.

45. The system of claim 43, further comprising means for processing the acquired signal with the processing finger.

46. The system of claim 39, further comprising means for selectively transferring at least one of the digital signal and the substantially interference-canceled signal to the first searcher finger in response to applying.

47. The system of claim 39, further comprising means for applying a first delay to the digital signal when generating the cancellation operator to generate a time delayed said digital signal.

48. The system of claim 39, further comprising means for acquiring, with a second searcher finger, the acquired signal from the digital signal.

49. A system, comprising:
means for substantially canceling one or more interfering signals from an input signal by applying a cancellation operator to the input signal to produce an output canceled signal;
means for performing acquisition to produce an acquired signal from the output canceled signal in response to substantially canceling the one or more interfering signals from the input signal.

50. The system of claim 49, further comprising means for providing for detection to a digital signal to produce a detected digital signal while detecting the acquired signal from the output canceled signal.

51. The system of claim 50, further comprising means for delaying the digital signal to account for a delay introduced by substantially canceling the one or more interfering signals.

52. The system of claim 50, further comprising means for processing either the detected digital signal or the acquired signal detected from the output canceled signal.

53. The system of claim 52, wherein the means for processing comprises:
means for tracking the selected signal; and
means for demodulating the selected signal to extract data from the selected signal.

54. The system of claim 49, further comprising means for generating the cancellation operator from an interference matrix constructed of the one or more interfering signals.

55. The system of claim 54, wherein the means for generating the cancellation operator comprises means for generating a projection operator according to the following form:
Pₛ^{⊥}=I−S(S^{T}S)⁻¹S^{T},
wherein Pₛ^{⊥} is the projection operator, I is an identity matrix, S is the interference matrix and S^{T} is a transpose of the interference matrix.

56. A handset, comprising:
a processor configured for substantially canceling one or more interfering signals from a digital signal to generate a substantially interference-canceled signal; and
a first searcher finger communicatively coupled to the processor and configured for performing acquisition to produce an acquired signal from the substantially interference-canceled signal.

57. The handset of claim 56, further comprising a processing finger communicatively coupled to the first searcher finger and configured for processing the acquired signal.

58. The handset of claim 57, further comprising a connection element configured for selectively transferring either an uncancelled signal or the substantially interference-canceled signal to the processing finger.

59. The handset of claim 56, further comprising a connection element configured for selectively transferring either the digital signal or the substantially interference-canceled signal to the first searcher finger for acquisition of the acquired signal.

60. The handset of claim 59, further comprising a buffer configured within the processor and communicatively coupled to the connection element, wherein the buffer is configured for applying a first delay to the digital signal.

61. The handset of claim 60, wherein the first delay comprises a duration of time corresponding to a second delay introduced by the processing engine.

62. The handset of claim 56, further comprising a second searcher finger configured for receiving a time-delayed said digital signal and for acquiring the acquired signal from the time-delayed said digital signal.

63. The handset of claim 62, wherein the second searcher finger is configurable within a processing engine and wherein the processing engine comprises the processor.

64. The handset of claim 56, wherein the first searcher finger is configurable within a processing engine and wherein the processing engine comprises the processor.

65. The handset of claim 56, further comprising a processing finger communicatively coupled to the first searcher finger for processing an acquired said acquired signal.

66. The handset of claim 56, further comprising a second searcher finger configurable within a receiver and wherein the receiver comprises a processing finger communicatively coupled for processing an acquired signal from either the first searcher finger or the second searcher finger.

67. The handset of claim 56, wherein the processor is configured for generating a cancellation operator, wherein the cancellation operator is adapted to be used to substantially cancel the one or more interfering signals from the digital signal.

68. The handset of claim 67, further comprising an applicator configured for applying the cancellation operator to an input signal to substantially cancel the one or more interfering signals from the input signal, wherein the input signal comprises the digital signal or a reference code.

69. The handset of claim 56, further comprising a matrix generator configured for generating a cancellation matrix adapted to be used to generate a cancellation operator, wherein the cancellation operator is adapted to be used to substantially cancel the one or more interfering signals from the digital signal.

70. The handset of claim 69, wherein the cancellation operator comprises the form:
Pₛ^{⊥}=I−S(S^{T}S)⁻¹S^{T},
wherein Pₛ^{⊥} is the cancellation operator, I is an identity matrix, S is the cancellation matrix and S^{T} is a transpose of the cancellation matrix.

71. The handset of claim 56, further comprising an interference selector configured for selecting the one or more interfering signals for cancellation from a plurality of interfering signals.

72. The handset of claim 56, wherein the acquired signal is one of a group, the group consisting of: a CDMA signal; a WCDMA signal; a UMTS signal; and a GPS signal.
